(19) United States
(12) Patent Application Publication
(10) Pub. No.: US 2012/0295094 A1
(43) Pub. Date: Nov. 22, 2012

(54) COMPOSITE ARTICLE OF GLASS PART AND PLASTIC PART AND METHOD FOR MANUFACTURING SAME

(75) Inventors: HUANN-WU CHIANG, Tu-Cheng (TW); CHENG-SHI CHEN, Tu-Cheng (TW); DUN MAO, Shenzhen City (CN); KONG-TING LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/293,531

(22) Filed: Nov. 10, 2011

(30) Foreign Application Priority Data
May 16, 2011 (CN) 201110125978.7

(51) Int. Cl. B32B 3/26; B29C 45/14

(52) U.S. Cl. 428/307.3; 264/279

(57) ABSTRACT

A composite article includes a glass part and a plastic part. The glass part includes a porous surface defining a plurality of nano-pores. Each nano-pore has a pore opening size between about 50 nm and about 200 nm. The plastic part is molded on the porous surface.

### BACKGROUND

1. Technical Field

The exemplary disclosure generally relates to composite articles of glass part and plastic part and methods for manufacturing the composite articles.

2. Description of Related Art

It is desirable to join glass parts and plastic parts. However, due to the two material having very different values of distinct physical and chemical properties, such as thermal expansion, it can be difficult to join glass and plastic using traditional bonding methods such as spot gluing.

Therefore, there is room for improvement within the art.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the exemplary embodiment of a composite article of glass part and plastic part and method for manufacturing the composite article. Moreover, in the drawings like reference numerals designate corresponding parts throughout the several views. Wherever possible, the same reference numbers are used throughout the drawings to refer to the same or like elements of an exemplary embodiment.

FIG. 1 illustrates a cross-sectional view of an exemplary embodiment of a glass part defining a plurality of nano-porous.

FIG. 2 illustrates a cross-sectional view of an exemplary embodiment of a composite article of a glass part of FIG. 1 and a plastic part.

### DETAILED DESCRIPTION

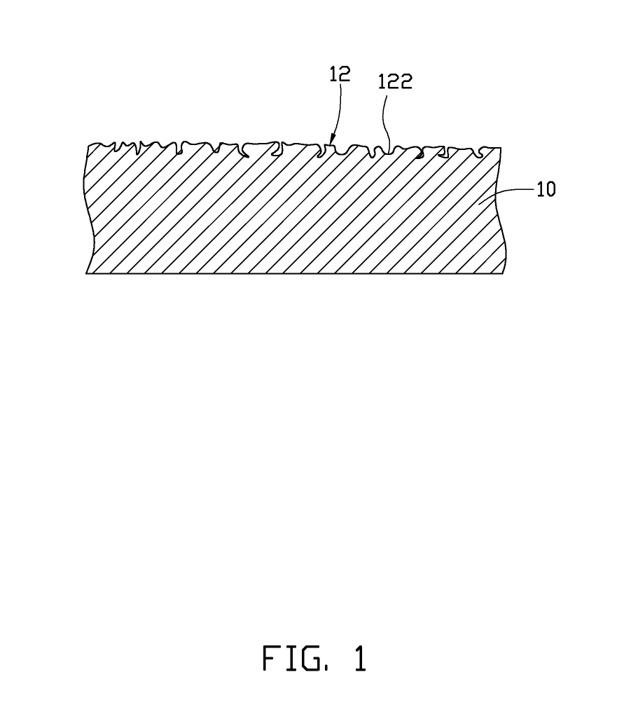

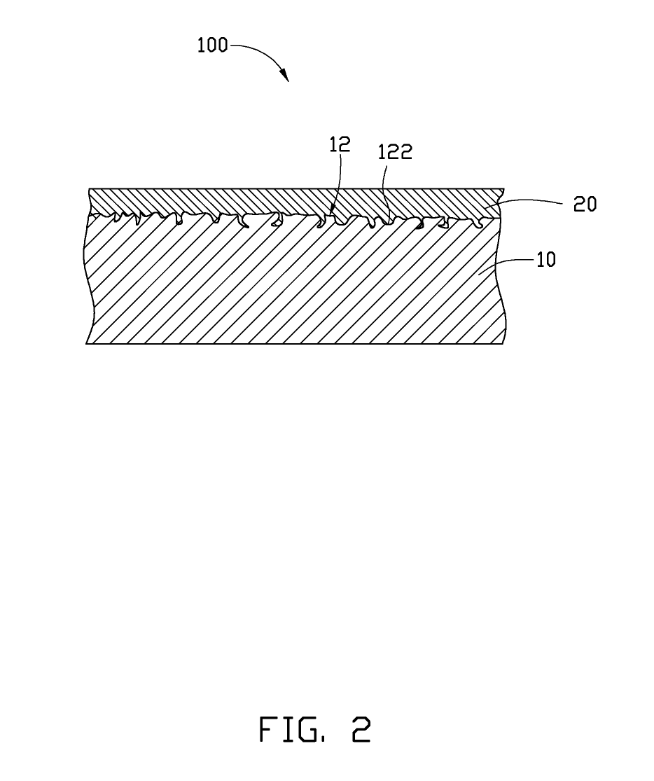

Referring to FIGS. 1 and 2, an exemplary embodiment of a composite article 100 includes a glass part 10 and a plastic part 20 molding on the glass part 10. The composite article 100 may be a housing of an electronic device.

The glass part 10 may be made of SiO₂. The glass part 10 includes a porous surface 12 defining a plurality of nano-pores 122 formed such as by chemical-etching. Each nano-pore 122 has a pore opening size between about 50 nanometers (nm) and about 200 nm, in this exemplary embodiment, the opening size is between about 60 nm and about 100 nm. The porous surface 12 can increase a bonding area between the glass part 10 and the plastic part 20 so a binding force between the glass part 10 and the plastic part 20 is improved. The plastic part 20 is bonded on the porous surface 12.

The plastic part 20 is formed by injection molding. The plastic part 20 may be made of polyphenylene sulfide (PPS). The liquid PPS has a good liquidity, thereby it can be easily flown into the nano-pores 122 during molding the plastic part 20. As a result, the binding force between the glass part 10 and the plastic part 20 is further improved. To improve the impact resistance of the plastic part 20, the plastic part 20 may be made of PPS added with glass fiber or carbon fiber. If the plastic part 20 is made of PPS added with glass fiber, the glass fiber can increase the expansive coefficient of the plastic part 20, as a result, the expansive coefficient of the plastic part 20 is approximate to the expansive coefficient of the glass part 10 so the binding force between the glass part 10 and the plastic part 20 is improved.

An exemplary method for manufacturing a composite article 100 may include at least the following steps.

Providing a glass part 10.

The glass part 10 is pretreated to remove impurities, such as grease or dirt. For example, the glass part 10 is washed with a solution including 5 wt %-10 wt % of nonylphenol polyoxyethylene ether and 8 wt %-15 wt % of fatty acid ester sodium at a temperature of 50 degree Celsius (° C.) to 80° C., for about 3 minutes (min) to 6 min.

The glass part 10 is chemically etched to form a porous surface 12 including a plurality of nano-pores 122. During chemical etching, the glass part 10 is put in an etching solution including HCl, NH₄F, H₂O₂, and H₂C₂O₄ for about 3 min to 6 min. The content of the hydrochloric acid is between about 40 wt % and about 50 wt % of the total weight of the etching solution. The content of the NH₄F is between about 20 wt % and about 30 wt % of the total weight of the etching solution. The content of the H₂O₂ is between about 1 wt % and about 2 wt % of the total weight of the etching solution. The content of the H₂C₂O₄ is between about 1 wt % and about 5 wt % of the total weight of the etching solution. The temperature of the etching solution is between about 30° C. and about 80° C. The hydrochloric acid in the etching solution is used to etch a plurality of nano-pores 122 in the porous surface 12. The H₂O₂ is used to improve the oxidizing power of the etching solution to further remove impurities, such as grease or dirt. The H₂C₂O₄ can be reacted with the NH₄F to make hydrochloric acid, which can complement hydrochloric acid in the etching solution as the hydrochloric acid already in the etching solution breaks down.

A mold is provide. The mold defines a mold cavity having the same shape and size as the composite article 100.

The glass part 10 is positioned in the mold cavity, and a gap is formed between the mold and the screen guard corresponding to the plastic part 20.

Liquid PPS is injected into the mold cavity to fill the gap and cover the porous surface 12 thereby forming the plastic part 20 on the glass part 10 to manufacture a composite article 100 with portions of the plastic part are filled into the nano-pores. During this stage, the temperature of the liquid PPS is between 300° C. and about 340° C.; the temperature of the mold is between 120° C. and 150° C.; the injection pressure of the liquid PPS is between about 1 MPa and about 4 MPa; the injection time of the liquid PPS is between about 0.5 seconds and about 1.5 seconds

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A composite article, comprising:
a glass part comprising a porous surface defining a plurality of nano-pores, each nano-pore having a pore opening size between about 50 nm and about 200 nm; and
a plastic part molded on the porous surface with portions of the plastic part filling the nano-pores.

2. The composite article as claimed in claim 1, wherein each nano-pore has a pore opening size between 60 nm and about 100 nm.

3. The composite article as claimed in claim 1, wherein the plastic part is made of polyphenylene sulfide.

4. The composite article as claimed in claim 1, wherein the plastic part is made of polyphenylene sulfide added with glass fiber.

5. The composite article as claimed in claim 1, wherein the plastic part is made of polyphenylene sulfide added with carbon fiber.

6. A method for manufacturing a composite article comprising steps of:
providing a glass part comprising a porous surface defining a plurality of nano-pores, each nano-pore having a pore opening size between about 50 nm and about 200 nm;
inserting the glass part into a mold; and
injecting liquid plastic into the mold to mold a plastic part on the porous surface with portions of the plastic part filling the nano-pores.

7. The method of claim 6, wherein each nano-pore has a pore opening size between 60 nm and about 100 nm.

8. The method of claim 6, wherein the plastic part is molded by injecting liquid polyphenylene sulfide into the mold.

9. The method of claim 8, wherein during molding the plastic part, the temperature of the liquid polyphenylene sulfide is between 300° C. and about 340° C.; the temperature of the mold is between 120° C. and 150° C.; the injection pressure of the liquid polyphenylene sulfide is between about 1 MPa and about 4 MPa; the injection time of the liquid polyphenylene sulfide is between about 0.5 seconds and about 1.5 seconds.

10. The method of claim 6, wherein the plastic part is molded of polyphenylene sulfide added with glass fiber.

11. The method of claim 6, wherein the plastic part is molded of polyphenylene sulfide added with carbon fiber.

12. The method of claim 6, wherein the porous surface is formed by chemical etching.

13. The method of claim 11, wherein during chemical etching, the glass part is put in a etching solution including hydrochloric acid, NH₄F, H₂O₂, and H₂C₂O₄ for about 3 min to 6 min; the content of the hydrochloric acid is between about 40 wt % and about 50 wt % of the total weight of the etching solution; the content of the NH₄F is between about 20 wt % and about 30 wt % of the total weight of the etching solution; the content of the H₂O₂ is between about 1 wt % and about 2 wt % of the total weight of the etching solution; the content of the H₂C₂O₄ is between about 1 wt % and about 5 wt % of the total weight of the etching solution; the temperature of the etching solution is between about 30° C. and about 80° C.
